(19) United States
(12) Patent Application Publication
(10) Pub. No.: US 2013/0246356 A1
(43) Pub. Date: Sep. 19, 2013

(54) SYSTEM, METHOD AND COMPUTER PROGRAM PRODUCT FOR PUSHING AN APPLICATION UPDATE BETWEEN TENANTS OF A MULTI-TENANT ON-DEMAND DATABASE SERVICE

(71) Applicant: SALESFORCE.COM, INC., San Francisco, CA (US)

(72) Inventors: James Taylor, San Francisco, CA (US); Andrew Smith, San Francisco, CA (US); Craig Weissman, San Francisco, CA (US)

(73) Assignee: salesforce.com, inc., San Francisco, CA (US)

(21) Appl. No.: 13/874,369

(22) Filed: Apr. 30, 2013

Related U.S. Application Data
(63) Continuation of application No. 12/784,666, filed on May 21, 2010.
(60) Provisional application No. 61/180,387, filed on May 21, 2009.

(51) Int. Cl. G06F 17/30

(52) U.S. Cl. CPC G06F 17/30377
USPC 707/629

(57) ABSTRACT

In accordance with embodiments, there are provided mechanisms and methods for pushing an application update between tenants of a multi-tenant on-demand database service. These mechanisms and methods for pushing an application update between tenants of a multi-tenant on-demand database service can enable tenants providing the application update to force instances of the application utilized by other tenants to be updated. This may allow the tenants providing the application update to ensure that instances of the application utilized by other tenants are updated.

### CLAIM OF PRIORITY

This application is a continuation of U.S. application Ser. No. 12/784,666, filed May 21, 2010, which claims the benefit of U.S. Provisional Patent Application No. 61/180,387, filed May 21, 2009, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to application updates, and more particularly to pushing application updates.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Conventionally, when a developer creates an application, the developer invariably also develops updates to that application over time for upgrading at least one feature of the application. Thus, in order for a user of the application to receive the benefit of an upgraded feature provided by a particular update, the user is generally required to install the update. Unfortunately, in traditional database systems managing, maintaining, etc. the updates for the developer, the user is required to initiate (e.g. request) the install of the update.

For example, the developer is generally limited to informing the user of the update, such that the developer is incapable of forcing the install of the update to the application of the user. This limitation oftentimes prevents the developer from ensuring that users of the application have a particular version, since for each available update various users of the application have the ability to selectively choose whether to update their respective instance of the application. Moreover, with such varying versions of the application in use by multiple users, the developer is unfortunately required to provide support for all of such various versions.

### BRIEF SUMMARY

In accordance with embodiments, there are provided mechanisms and methods for pushing an application update between tenants of a multi-tenant on-demand database service. These mechanisms and methods for pushing an application update between tenants of a multi-tenant on-demand database service can enable tenants providing the application update to force instances of the application utilized by other tenants to be updated. This may allow the tenants providing the application update to ensure that instances of the application utilized by other tenants are updated.

In an embodiment and by way of example, a method is provided for pushing an application update between tenants of a multi-tenant on-demand database service. In use, an update to an application is received from a first tenant of a multi-tenant on-demand database service. Furthermore, the update is automatically pushed to at least one instance of the application utilized by a respective second tenant of the multi-tenant on-demand database service.

While the present invention is described with reference to an embodiment in which techniques pushing application updates between tenants of a multi-tenant on-demand database service are implemented in an application server providing a front end for a multi-tenant on-demand database service, the present invention may not necessarily be limited to multi-tenant databases or deployment on application servers. Embodiments may be practiced using other database architectures, i.e., ORACLE®, DB2® and the like without departing from the scope of the embodiments claimed.

Any of the above embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

FIG. 1 shows a method for pushing an application update between tenants of a multi-tenant on-demand database service, in accordance with one embodiment.

FIG. 2 shows a method for pushing an update to an application received from a first tenant of a multi-tenant on-demand database service to a second tenant of the multi-tenant on-demand database service, in accordance with another embodiment.

FIG. 3 shows a system for pushing an application update between tenants of a multi-tenant on-demand database service, in accordance with vet another embodiment.

FIG. 4 shows a system in which cross-instance messaging is provided for pushing an application update between tenants of a multi-tenant on-demand database service, in accordance with still yet another embodiment.

FIG. 5 illustrates a block diagram of an example of an environment wherein an on-demand database service might be used.

FIG. 6 illustrates a block diagram of an embodiment of elements of FIG. 5 and various possible interconnections between these elements.

### DETAILED DESCRIPTION

### General Overview

Systems and methods are provided for pushing an application update be ween tenants of a multi-tenant on-demand database service.

To date, tenants of a multi-tenant on-demand database service have been limited to simply informing other tenants of updates to applications that are available to be installed, such that the other tenants may be selective in updating the applications. As a result, tenants providing such updates have been incapable of forcing updates to the applications utilized by other tenants of the multi-tenant on-demand database.

Thus, mechanisms and methods are provided for pushing an application update between tenants of a multi-tenant on-demand database service. These mechanisms and methods for pushing an application update between tenants of a multi-tenant on-demand database service can enable tenants providing the application update to force instances of the application utilized by other tenants to be updated, which may further allow the tenants providing the application update to ensure that instances of the application utilized by other tenants are updated.

Next, mechanisms and methods for pushing an application update between tenants of a multi-tenant on-demand database service will be described with reference to exemplary embodiments.

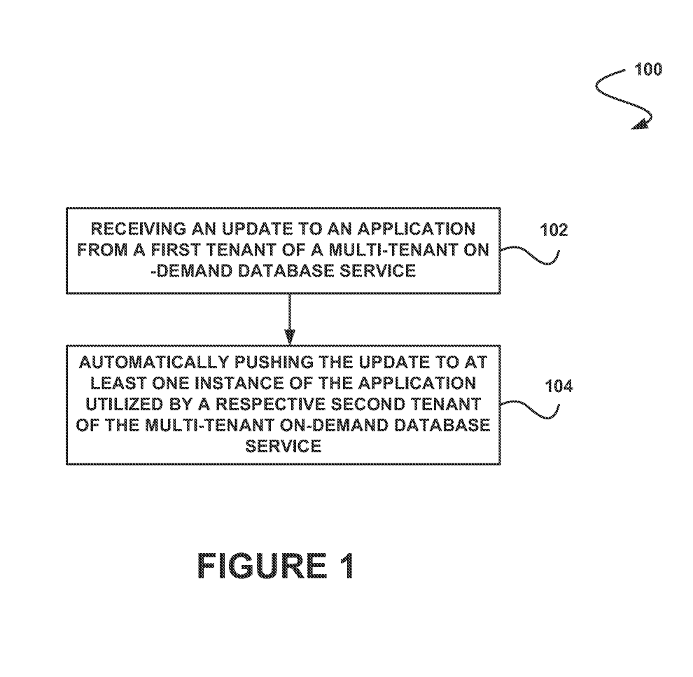

FIG. 1 shows a method 100 for pushing an application update between tenants of a multi-tenant on-demand database service, in accordance with one embodiment. As shown, in operation 102, an update to an application is received form a first tenant of a multi-tenant on-demand database service. In the present description, such multi-tenant on-demand database service may include any service that relies on a database system that is accessible over a network, in which various elements of hardware and software of the database system may be shared by one or more customers (e.g. tenants). For instance, a given application server may simultaneously process requests for a great number of customers, and a given database table may store rows for a potentially much greater number of customers. Various examples of such a multi-tenant on-demand database service will be net forth in the context of different embodiments that will be described during reference to subsequent figures.

To this end, the first tenant of the multi-tenant on-demand database service may include a customer, user, etc. of the above-defined multi-tenant on-demand database service from which the update to the application is received. In one embodiment, the first tenant may include a developer of the update. In another embodiment, the first tenant may include a developer of the application. For example, the first tenant may utilize the multi-tenant on-demand database service, such as a platform, applications, application program interfaces (APIs), etc. of the multi-tenant on-demand database service to generate the application and/or the update.

It should be noted that the application may include any computer code, package, etc. capable of being utilized by another tenant of the multi-tenant on-demand database service. In addition, the application may include a previously updated version of the application. Moreover, the update may include any update to at least one feature of such application. Thus, the update may be specific to the application. Just by way of example, the application update may include a patch to the application (e.g. for fixing a bug, error, etc. in the application). In this way, the update to the application may include a new version of the application, such that applying the update to the application may change the application from a previous version to a version associated with the update.

In one embodiment, the update to the application may be received by the first tenant uploading the update to the multi-tenant on-demand database service. Just by way of example, the first tenant may utilize a user interface of the multi-tenant on-demand database service to communicate the update to the application to the multi-tenant on-demand database service. Such user interface may include a field for the first tenant to enter a major, minor and update version number associated with the update, such that the multi-tenant on-demand database service may ensure that the value entered in the field is greater than a prior version of the application. In another embodiment, the update to the application may be received by the first tenant creating the update utilizing the multi-tenant on-demand database service and further publishing (e.g. approving, finalizing, etc.) the update for use in updating the application.

Furthermore, as shown in operation 104, the update is automatically pushed to at least one instance of the application utilized by a respective second tenant of the multi-tenant on-demand database service. With respect to the present description, such second tenant may include any customer, user, etc. of the above-defined multi-tenant on-demand database service that utilizes (e.g. has access to use) an instance of the application. Thus, each instance of the application may be utilized by one of a plurality of different second tenants of the multi-tenant on-demand database service, such that each of the second tenants has an independent copy of the application for the second tenant's sole use.

In one embodiment, the multi-tenant on-demand database service may include a plurality of instances (e.g. partitions, servers, etc.), where each tenant is associated with one of such instances. For example, the applications utilized, created, etc. by a tenant of the multi-tenant on-demand database service may be located on the instance with which such tenant is associated. Optionally, each instance of the multi-tenant on-demand database service may be associated with a single tenant or multiple tenants. To this end, automatically pushing the update to the instance of the application utilized by a tenant may include pushing the update to the instance of the multi-tenant on-demand database service associated with such tenant (e.g. on which the instance of the application utilized by such tenant is located). In one exemplary embodiment, the instance of the application utilized by the respective second tenant may be installed on a first instance of the multi-tenant on-demand database service separate from a second instance of the multi-tenant on-demand database service by which the update is received, such that the update may be replicated from the second instance to the first instance for automatically pushing the update to the at least one instance of the application utilizing the first instance.

In one embodiment, automatically pushing the update to an instance of the application may include performing installation of the update with respect to the instance of the application. Thus, the update may be automatically pushed such that the instance of the application is automatically updated (e.g. to a new version) utilizing the update received from the first tenant. In this way, the update may be automatically pushed such that the instance of the application is updated utilizing the update without intervention from the second tenant (e.g. the update may be forced upon the instance of the application). For example, the automation of the push may avoid a requirement and/or capability of the second tenant to intervene or otherwise control, manage, etc. the update to the instance of the application.

It should be noted that the update may be automatically pushed to the instance of the application by the multi-tenant on-demand database service. Thus, based on receipt of the update at the multi-tenant on-demand database service from the first tenant, the multi-tenant on-demand database service may push such update to the instance of the application utilized by the second tenant. As another option, the update may be automatically pushed to the instance of the application in response to a request from the first tenant to push the update to the instance of the application.

As yet another option, the update may be automatically pushed to the instance of the application based on a schedule configured by the first tenant. The schedule may be configured utilizing a graphical user interface (GUI) of the multi-tenant on-demand database service. For example, the GUI may be associated with an account of the first tenant provided by the multi-tenant on-demand database service.

Further, the schedule may indicate a time period (e.g. start time and/or end time) during which the update is allowed to be automatically pushed to the instance of the application. In one embodiment, the time period may include a start time and an end time. The start time may optionally be restricted by the multi-tenant on-demand database service based on a time required to replicate the update across the aforementioned plurality of instances of the multi-tenant on-demand database service (e.g. as predetermined by the multi-tenant on-demand database service).

In another embodiment, the schedule may indicate the second tenant whose instance of the application is to receive the automatically pushed update. Thus, the first tenant may optionally specify only a subset of second tenants utilizing a respective instance of the application to which the update is to be automatically pushed. Of course, it should be noted that while various embodiments of the manner in which the update may be automatically pushed to the instance of the application have been described above, the first tenant may optionally configure the manner in which the update is to be automatically pushed to the instance of the application as desired. By allowing updates to be pushed in the manner described above, an update can be deployed to a single tenant in the same database of the multi-tenant on-demand database service as another tenant, while not updating such other tenant with the same application installed. Also, the push update may allow tenants to continue to use the application while it is being updated, while at least substantially maintaining transparency of the update (e.g. the tenant may not necessarily be locked out of the application and the application may not be required to take downtime for the update to be installed).

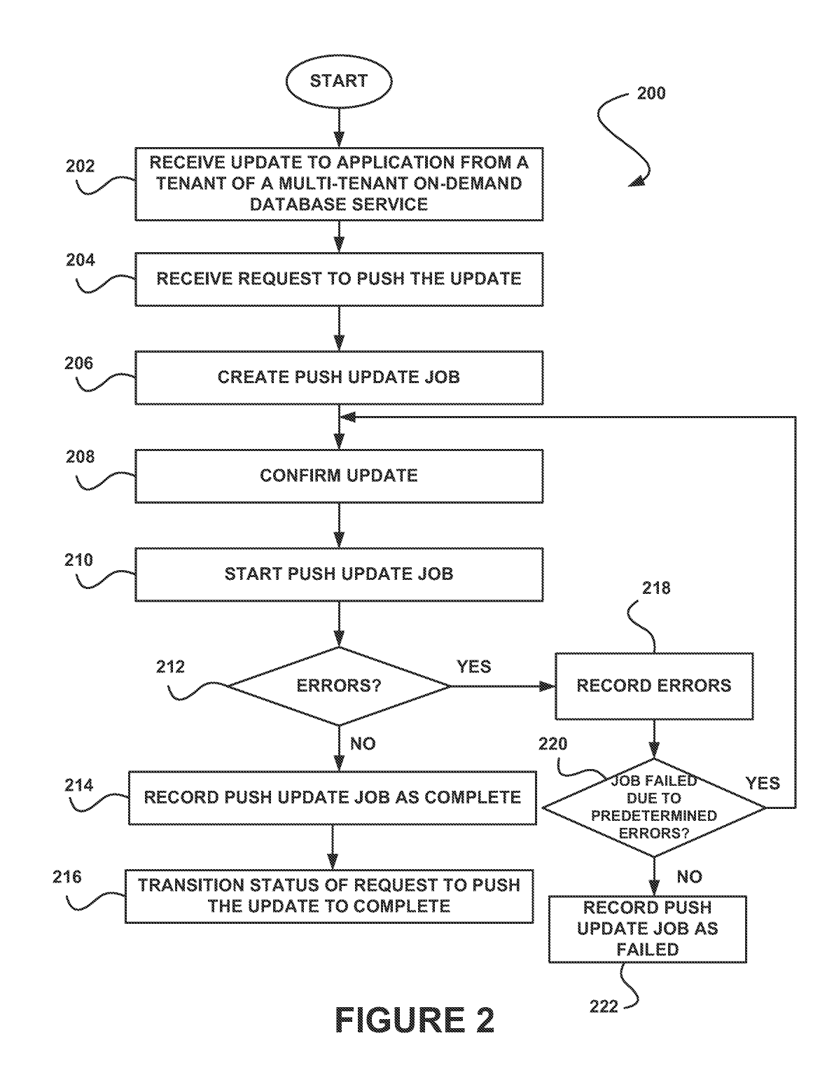

FIG. 2 shows a method 200 for pushing an update to an application received from a first tenant of a multi-tenant on-demand database service to a second tenant of the multi-tenant on-demand database service, in accordance with another embodiment. As an option, the present method 200 may be implemented in the context of the functionality of FIG. 1. Of course, however, the method 200 may be carried out in any desired environment. The aforementioned definitions may apply during the present description.

As shown in operation 202, an update to an application is received from a first tenant of a multi-tenant on-demand database service. In the context of the present embodiment, the first tenant includes a developer of the application and the update to the application. For example, the developer may log into a development organization (e.g. platform) of the multi-tenant on-demand database service to create the application and subsequently the update to the application, such that the multi-tenant on-demand database service may receive the application and its update. As another example, the update to the application may be uploaded by the first tenant to the multi-tenant on-demand database service.

In one embodiment, the update may be for a managed application of the multi-tenant on-demand database service. Such managed application may include an application for which changes included in updates to the application are constrained by the multi-tenant on-demand database service. Thus, the present method 200 may optionally be limited to pushing updates to such managed applications.

In another embodiment, the update may include a patch to the application. For example, the patch may include a fix to an error existing in the application. Optionally, the update may be uploaded in a patch branch development organization that was cloned from an original mainline development organization. Accordingly, the present method 200 may optionally be limited to pushing a patch to an application, such that more significant updates to the application may optionally be prevented from being allowed to be automatically pushed.

Upon receipt of the update, an all package version (APV) row to a database of the multi-tenant on-demand database service may optionally be created to reflect the update. The database may store in each row an indication of a different version of an application. Furthermore, the update may be replicated to each instance of the multi-tenant on-demand database service, in response to receipt of the update.

As shown in operation 204, a request to push the update is received. For example, the request may be received from (and configured by) the first tenant from which the update was received. Thus, the request may be received by the multi-tenant on-demand database service. In the present embodiment, such request may include a request to push the update to at least one instance of the application utilized by a respective second tenant of the multi-tenant on-demand database service.

In one embodiment, the request may indicate a mode in which the update is to be pushed to the instance of the application. The mode may include a test mode, whereby the update is pushed to the instance of the application but not actually applied (i.e. committed). Thus, pushing the update to the instance of the application in the test mode will return results (e.g. success, failure, etc.) of pushing the update to the instance of the application, without necessarily applying the update to the instance of the application (e.g. for allowing the first tenant to identify errors that would occur were the update applied to the instance of the application and fix a source of such errors prior to applying the update to the instance of the application).

As another option, the mode may include a commit mode, whereby the update is pushed to the instance of the application, such that the update is applied to the instance of the application. Such commit mode may include, in one embodiment, performing the aforementioned test push, and subsequently applying the update to the instance of the application only in response to a result of the test push being successful. In one embodiment, the push may optionally only be allowed to be run in commit mode after the push has been run in test mode with at least a predetermined threshold amount of success and within a predetermined amount of time.

In another embodiment, the request may indicate at least one second tenant utilizing an instance of the application to which the update is to be pushed. Optionally, the first tenant may select such second tenant from a list of second tenants that utilize an instance of the application (e.g. by filtering the list by tenant name, tenant identifier, location of the instance of the application, etc.). For example, the instance of the application being utilized by such second tenants may include a version of the application immediately previous to the version associated with the update (e.g. an instance of the application on a same major and minor version and an earlier patch version).

In yet another embodiment, the request may include a schedule indicating a time period during which the update is allowed to be pushed to the instance of the application. The time period may include a start time and end time between which the update is allowed to be pushed to the instance of the application. As an option, the start time and end time may represent a time period when usage of the instance of the application is historically shown to be below a threshold amount.

As another option, the start time may be limited to being a predetermined minimum start time configured by the multi-tenant on-demand database service or any time later than such predetermined minimum start time. For example, the predetermined minimum start time may include a time allowing for an amount of time from receipt of the request (or receipt of the update) to replicate the update to each instance of the multi-tenant on-demand database service. Thus, by limiting the start time based on the predetermined minimum start time, it may be ensured that each instance of the multi-tenant on-demand database service has had sufficient time to receive a replicated instance of the update.

As yet another option, the end time may be limited to being at least a predetermined amount of time after the start time. For example, such predetermined amount of time may be an amount of time historically shown (e.g. using prior push update statistics identified when the pushing the update in a test mode) to be required to push an update to an instance of the application.

In response to receipt of the request to push the update, a push update job is created. Note operation 206. The push update job may include an indication of the work needed to be performed in order to push the update to the instance of the application and may be created for each instance of the application to which the update is to be pushed (e.g. as defined by the request). Optionally, the push update job may only be created in response to a determination that a time period during which the update is allowed to be pushed to the instance of the application (as described above) has began (e.g. that the current time is later than the start time of such time period).

Furthermore, the update is confirmed, as shown in operation 208. Thus, the update to the instance of the application may be confirmed prior to automatically pushing the update to the instance of the application. For example, the update may be confirmed for each push update job.

In one embodiment, confirming the update may include verifying that the request to push the update has not been cancelled (e.g. by the first tenant). In another embodiment, confirming the update may include verifying that the instance of the application utilized by the respective second tenant is installed (e.g. that the second tenant has not uninstalled the instance of the application). In yet another embodiment, confirming the update may include verifying that the period during which the update is allowed to be pushed to the instance of the application (as described above) has not passed (e.g. that the current time is not later than the end time of such time period).

In still yet another embodiment, confirming the update may include verifying that a major and minor version to which the update is applicable matches a major and minor version of the instance of the application utilized by the respective second tenant. Optionally, the update may be a re-push of the update to the instance of the application if only a single instance of the application is requested to be updated via the push.

The confirmation of the update may further include confirming that the second tenant exists (e.g. a correct identifier of the second tenant has been provided by the first tenant when scheduling the push update).

It should be noted that if the update is not confirmed for a particular push update job, the method 200 may terminate with respect to such particular push update job and an error may optionally be generated. Once the update is confirmed, however, the push update job is started. Note operation 210. In this way, the update may be automatically pushed to the instance of the application based on the confirmation. For example, pushing of the update to the instance of the application may be initiated (e.g. using APIs of the multi-tenant on-demand database service), and it may optionally be ensured that settings (e.g. profile mappings, etc.) from a version of the instance of the application prior to the update are carried forward correctly when pushing the update to the instance of the application. Optionally, upon starting the push update job, a status of the push update job may be transitioned to “started” and the start date of such push update job may be recorded in an autonomous transaction.

Additionally, as shown in decision 212, it is determined whether any errors have been generated as a result of the automatic push of the update to the instance of the application. With respect to the present embodiment, the errors may include any that occurred as a result of the push of the update to the instance of the application. If errors are not identified, the push update job is recorded as complete. Note operation 214. For example, a status of the push update job is transitioned to complete.

Moreover, a status of the request to push the update (received in operation 204) is transitioned to complete, as shown in operation 216. In one embodiment, the status of the request to push the update may optionally only be transitioned to complete upon all push update jobs created based on the request being recorded as complete. Thus, the status of the request may indicate an overall state of pushing the update to all instances of the application specified by the request.

In decision 212, if it is determined that errors have been generated as a result of the automatic push of the update to the instance of the application, the errors are recorded. Note operation 218. For example, the errors may be recorded in a push update job error table. It is further determined in decision 220 whether the push update job failed due to predetermined ones of the errors. Such predetermined errors may include those which are capable of not reoccurring during a subsequent attempt to push the update to the instance of the application. For example, the predetermined errors may include the update not being present on (not yet being replicated to) an instance of the multi-tenant on-demand database service associated with the second tenant whose instance of the application is to receive the update via the push. As another example, the predetermined errors may include the instance of the application being in use by the second tenant, such that a schema or application lock necessary to update the application could not be acquired.

If it is determined that the push update job failed due to at least one of the predetermined ones of the errors, the push update job is again confirmed in operation 208 for starting the push update job in operation 210. In this way, the push of the update to the instance of the application may be re-initiated (e.g. automatically), based on the errors (e.g. in response to a determination that the errors include predetermined errors). If it is determined that the push update job failed due to at least one error other than the predetermined ones of the errors, the push update job is recorded as failed, as shown in operation 222.

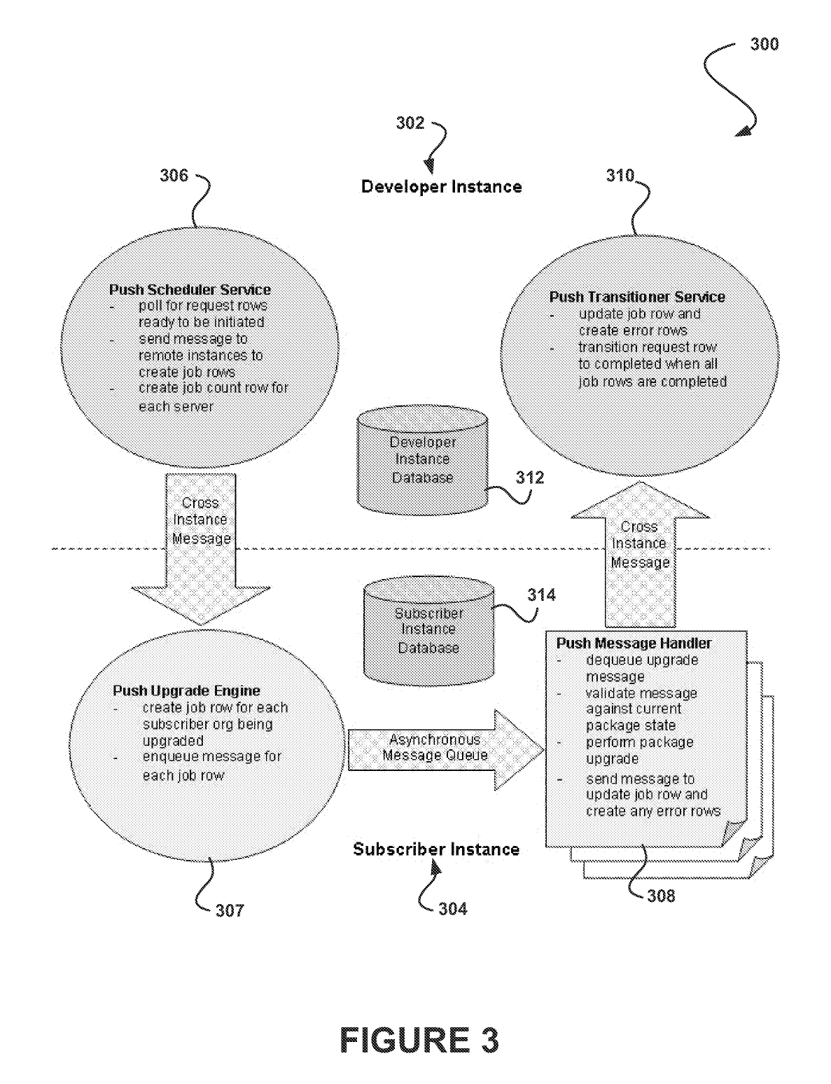

FIG. 3 shows a system 300 for pushing an application update between tenants of a multi-tenant on-demand database service, in accordance with yet another embodiment. As an option, the system 300 may be implemented in the context of the functionality of FIGS. 1-2. Of course, however, the system 300 may be implemented in any desired environment. Again, the aforementioned definitions may apply during the present description.

As shown, a developer instance 302 and a subscriber instance 304 exist in a multi-tenant on-demand database service. In the context of the present embodiment, the developer instance includes an instance of the multi-tenant on-demand database service at which an update to an application is received from a first tenant, and the subscriber instance includes an instance of the multi-tenant on-demand database service on which an instance of the application utilized by a second tenant is located. Thus, the developer instance 302 and the subscriber instance 304 may be separate instances of the multi-tenant on-demand database service. While the developer instance 302 and the subscriber instance 304 are shown as separate instances of the multi-tenant on-demand database service, it should be noted that the components described below with respect to each of the developer instance 302 and the subscriber instance 304 may be located on both of developer instance 302 and the subscriber instance 304, to account for the situation where the update to the application is received by the same instance of the multi-tenant on-demand database service on which the aforementioned instance of the application is located.

Initially, the developer instance 302 receives an update to the application from the first tenant and a request to push the update to an instance of the application located on the subscriber instance 304. The update may optionally be stored in a developer instance database 312. In response to receipt of the request, the request is inserted into the developer instance database 312 as a row of the developer instance database 312.

A push schedule service 306 of the developer instance 302 polls the developer instance database 312 for requests included therein that are ready to be initiated. For example, the push schedule service 306 may use a schedule included in each request for determining whether such request is ready to be initiated (e.g. by comparing a start time associated with the request with a current time, etc.). Upon identification of a request that is ready to be initiated, the push schedule service 306 sends a cross instance message to a push upgrade engine 307 of the subscriber instance 304 instructing the push upgrade engine 307 to create a push update job for each instance of the application located on the subscriber instance 304 to which the update is to be pushed (e.g. as defined by the request). The push schedule service 306 further creates it the developer instance database 312 a push update job count row for the subscriber instance indicating a number of the push update jobs that the push upgrade engine 307 was instructed to create.

Upon receipt by the push upgrade engine 307 of the cross instance message from the push schedule service 306, the push upgrade engine 307 creates the push update jobs as instructed by the push schedule service 306 and creates in a subscriber instance database 314 (e.g. storing the instance of the application) a push update job row for each instance of the application located on the subscriber instance 304. The push update jobs are then enqueued in an asynchronous message queue by enqueuing a message for each push update job row.

A push message handler 308 of the subscriber instance 304 accesses the asynchronous message queue and dequeues a first message included therein. The message is processed to confirm the update to the instance of the application associated with the message (e.g. by confirming that the request has not been cancelled, etc.). Once the update is confirmed, the update is automatically pushed to the instance of the application for updating the application using existing APIs of the multi-tenant on-demand database service.

Upon pushing the update to the instance of the application, a status of the associated push update job row associated with the push update job is transitioned to “started” and the start data is recorded in an autonomous transaction, using the push message handler 308. The push message handler 308 also sends a cross instance message to a push transitioner service 310 of the developer instance 302 instructing the push transitioner service 310 to transition the push update job on the developer instance 302 to “started”. Errors resulting from the pushing of the update to the instance of the application are recorded by the push message handler 308 creating error rows in a push update job error table of the subscriber instance database 314. The push transitioner service 310 is also notified of such errors via a cross instance message from the push message handler 308.

Upon receipt of the cross instance message by the push transitioner service 310 instructing that the push update job on the developer instance 302 be transitioned to “started”, the push update job row in the developer instance database 312 associated with the push update job is updated to reflect the “started” status. Similarly, upon receipt of the cross instance message by the push transitioner service 310 notifying the push transitioner service 310 of the errors, the push transitioner service 310 records the errors by creating error rows in a push update job error table of the developer instance database 312.

Upon completion of successfully pushing the update to the instance of the application, the push message handler 308 transitions a status of the associated push update job row to “succeeded”, records the end date, and sends a cross instance message to the push transitioner service 310 indicating such “succeeded” status. In response, the push transitioner service 310 updates the push update job row in the developer instance database 312 associated with the push update job to reflect the “succeeded” status. The push transitioner service 310 may continuously poll the push update job rows in the developer instance database 312 to determine whether all of the associated push update jobs have been completed.

Upon failure of a push of the update to an instance of the application (e.g. due to errors identified by the push message handler 308), the associated push update job may optionally be automatically restarted by the push message handler 308 (e.g. if the errors are predetermined errors) or may transition a status of the associated push update job row to “failed”, record the end date, and send a cross instance message to the push transitioner service 310 indicating such “failed” status. In this way, the push transitioner service 310 may also transition an associated push update job row in the developer instance database to reflect the “faded” status. Once the push transitioner service 310 determines that all of the associated push update jobs have either a “succeeded” or “failed” status, the request row of the developer instance database 312 may be transitioned to a “succeeded” status if all jobs have a “succeeded” status, or “failed” otherwise. The push transitioner service 310 may optionally notify the first tenant (e.g. via email) when the status of the request is “completed” (i.e. either “succeeded” or “failed”).

While various statuses have been described above, it should be note that the developer instance 302 and the subscriber instances 304 may track multiple statuses, such as “pending” (a request has been scheduled but not yet started), “in progress” (a request has started but all jobs have not completed yet), “succeeded” (all jobs have successfully completed), “failed” (one or more jobs have failed), or “aborted” (if the first tenant aborts the push).

In one embodiment, a push update status page may be displayed to the first tenant via a user interface of the multi-tenant on-demand database service, where the push update status page pulls the status of each push update job associated with a particular request and presents the status in association with an identifier of the associated push update job. For example, the push update status page may include a table listing all second tenants for which the update was successfully pushed, a table listing all second tenants for which the update is pending, a table listing all second tenants for which the update failed, a description of the errors that resulted in the failure, performance metrics, and an option for the first tenant to manually re-initiate a push update job associated with a failed push update job. In yet another embodiment, another page may be displayed to the first tenant via a user interface of the multi-tenant on-demand database service for presenting a global view of a push update status for all development organizations on a particular instance associated with various tenants, with links into the push update status page for each.

In another embodiment, an installed packages page may be displayed to the first tenant via a user interface of the multi-tenant on-demand database service. The installed packages page may present a current major, minor and update version number of each installed application along with a date it was last updated. As another option, the installed packages page may present a latest update version number, such that in the event an instance of an application fails to be updated with the latest update, detailed information about the reason for the failure may be provided along with schedule information if a push update is pending.

Still yet, Table 1 shows one example of a set of tables that may be included in each of the developer instance database 312 and the subscriber instance database 314 for storing the request for a push of an update to at least one instance of an application, a status of such request, and schedule information associated with the request. Of course it should be noted that the table shown in Table 1 is set forth for illustrative purposes only, and thus should not be construed as limiting in any manner.

TABLE 1
-- Non partitioned table for the overall package upgrade request.
-- Originates in the dev org and is replicated to subscriber
-- org instances through cross instance messaging.
-- Each push request causes a new row to be created.
CREATE TABLE core.push_upgrade_request(

| | | |
|---|---|---|
| push_upgrade_request_id | CHAR(15) | NOT NULL, |
| dev_organization_id | CHAR(15) | NOT NULL, |
| system_modstamp | DATE | NOT NULL |

DEFAULT SYSDATE,

| | | |
|---|---|---|
| server_id | CHAR(1) | NOT NULL, |
| created_date | DATE | NOT NULL |

DEFAULT SYSDATE,

| created_by | CHAR(15) | NOT NULL, |
|---|---|---|
| all_package_version_id | CHAR(15) | NOT NULL, |
| scheduled_start_date | DATE | NOT NULL, |
| scheduled_end_date | DATE | NOT NULL, |
| -- pending, in-progress, succeeded, failed, canceled | | |
| status | CHAR(1) | NOT NULL, |
| -- validate, upgrade | | |
| stage | CHAR(1) | NOT NULL, |
| -- validate-only, validate-all-before-upgrade, best-effort-upgrade | | |
| options | NUMBER | NOT NULL, |
| -- all-instances, prod-instances, sandbox-instances, specific-orgs | | |
| destination_type | CHAR(1) | NOT NULL |

);
-- pk for push upgrade request table
CREATE UNIQUE INDEX core.pkpush_upgrade_request ON

core.push_upgrade_request (push_upgrade_request_id);

-- ak for push upgrade request table
-- Only one active upgrade request may exist for a given APV.
CREATE UNIQUE INDEX core.akpush_upgrade_request ON

core.push_upgrade_request (all_package_version_id,
CASE WHEN destination_type=“O” OR (status!=“P” AND
status!=“I”) THEN push_upgrade_request_id END);

-- fk for dev org id
CREATE INDEX core.iepush_upgd_req_dev_org ON
core.push_upgrade_request

(dev_organization_id);

-- fk for scheduler finding work to do
CREATE INDEX core.iepush_upgd_req_sched_start ON

core.push_upgrade_request
(status, scheduled_start_date);

-- Non partitioned table to provide count of subscriber orgs
-- being upgraded on each instance.
-- Originates in the dev org and is not replicated.
CREATE TABLE core.push_upgrade_job_count(

| | | |
|---|---|---|
| push_upgrade_job_count_id | CHAR(15) | NOT NULL, |
| system_modstamp | DATE | NOT NULL |

DEFAULT SYSDATE,

| | | |
|---|---|---|
| created_date | DATE | NOT NULL |

DEFAULT SYSDATE,

| | | |
|---|---|---|
| push_upgrade_request_id | CHAR(15) | NOT NULL, |
| server_id | CHAR(1) | NOT NULL, |
| stage | CHAR(1) | NOT NULL, |
| job_count | NUMBER, | NOT NULL, |

DEFAULT 0

);
-- pk for push upgrade job count table
CREATE UNIQUE INDEX core.pkpush_upgrade_job_count ON

core.push_upgrade_job_count
(push_upgrade_job_count_id);

-- ak for push upgrade job count table
-- Only one active upgrade request status may exist for a given sever
-- for an upgrade request in a given stage.
CREATE UNIQUE INDEX core.akpush_upgrade_job_count ON

core.push_upgrade_job_count
(push_upgrade_request_id, stage, server_id);

-- Non partitioned table for package upgrade request when
-- only a subset of the subscriber orgs are being upgraded.
-- Originates in the dev org and is not replicated.
CREATE TABLE core.push_upgrade_request_org(

| | | |
|---|---|---|
| push_upgrade_request_org_id | CHAR(15) | NOT NULL, |
| sub_organization_id | CHAR(15) | NOT NULL, |
| system_modstamp | DATE | NOT NULL |

DEFAULT SYSDATE,

| | | |
|---|---|---|
| push_upgrade_request_id | CHAR(15) | NOT NULL |

);
-- pk for push upgrade request org table
CREATE UNIQUE INDEX core.pkpush_upgrade_request_org ON

core.push_upgrade_request_org
(push_upgrade_request_org_id);

-- ak for push upgrade subscriber request table
CREATE UNIQUE INDEX core.akpush_upgrade_request_org ON

core.push_upgrade_request_org (push_upgrade_request_id,
sub_organization_id);

-- fk for subscriber org
CREATE INDEX core.iepush_upgd_req_org_sub_org ON

core.push_upgrade_request_org
(sub_organization_id);

-- Non partitioned table for package upgrade attempt for a given
-- installed package in a subscriber org.
-- Originates in the subscriber org and is replicated back to
-- dev instance through cross instance messaging.
CREATE TABLE core.push_upgrade_job(

| | | |
|---|---|---|
| push_upgrade_job_id | CHAR(15) | NOT NULL, |
| sub_organization_id | CHAR(15) | NOT NULL, |
| system_modstamp | DATE | NOT NULL |

DEFAULT SYSDATE,

| | | |
|---|---|---|
| server_id | CHAR(1) | NOT NULL, |
| created_date | DATE | NOT NULL |

DEFAULT SYSDATE,

| | | |
|---|---|---|
| push_upgrade_request_id | CHAR(15) | NOT NULL, |
| status | CHAR(1) | NOT NULL, |
| stage | CHAR(1) | NOT NULL, |
| start_date | DATE, | |
| end_date | DATE | |

);
-- pk for push upgrade job table
CREATE UNIQUE INDEX core.pkpush_upgrade_job ON
core.push_upgrade_job

(push_upgrade_job_id);

-- ak for push upgrade job table
CREATE UNIQUE INDEX core.akpush_upgrade_job ON
core.push_upgrade_job

(push_upgrade_request_id, sub_organization_id);

-- fk to get status info for all installed packages of a given

subscriber org

CREATE INDEX core.iepush_upgrade_job_sub_org ON
core.push_upgrade_job

(sub_organization_id);

Table 2 shows one example of a table that may be included in each of the developer instance database 312 and the subscriber instance database 314 for storing information if a failure occurs during a push of an update to an instance of an application. Of course it should be noted that the table shown in Table 2 is set forth for illustrative purposes only, and thus should not be construed as limiting in any manner.

TABLE 2
-- Non partitioned table for push upgrade errors
-- 0:many with push_upgrade_job since multiple errors
-- may occur in the attempt to upgrade the installed
-- package in the subscriber org.
-- Originates in the subscriber org and is replicated
-- back to the dev org through cross instance messaging.
CREATE TABLE core.push_upgrade_job_error(

| | | |
|---|---|---|
| push_upgrade_job_error_id | CHAR(15) | NOT NULL, |
| system_modstamp | DATE | NOT NULL |

DEFAULT SYSDATE,

| | | |
|---|---|---|
| server_id | CHAR(1) | NOT NULL, |
| created_date | DATE | NOT NULL |

DEFAULT SYSDATE,

| | | |
|---|---|---|
| push_upgrade_job_id | CHAR(15) | NOT NULL, |
| error_code | VARCHAR2(120) | NOT NULL, |
| error_message | VARCHAR2(500) | NOT NULL, |
| error_stack | VARCHAR2(4000) | |

);
-- pk for push upgrade job error table
CREATE UNIQUE INDEX core.pkpush_upgrade_job_error ON

core.push_upgrade_job_error (push_upgrade_error_id);

-- fk to push upgrade job error table
CREATE INDEX core.iepush_upgd_job_err_job ON

core.push_upgrade_job_error
(push_upgrade_job_id);

As an option, a number of pending and in-progress push update requests from a single tenant may be limited to a predetermined number (e.g. 1). As another option, such limit may not necessarily be applied to a predetermined set of tenants, such that the predetermined set of tenants may be enabled to request a push update in a test mode only.

As yet another option, To prevent a single large push request from using up all of the push message handler threads 308 of the multi-tenant on-demand database service, prioritized queues may be used to ensure push update jobs from each push update request are interleaved with each other. Each push update job may be assigned an integer priority value, such that each time a push update job is going to be enqueued, the priority of the next push update job to be processed may be identified used as a starting value for the set of pending push update jobs.

Just by way of example, if a first developer tenant requests a push update of 100 instances of a first application, each utilized by a respective subscriber tenant, separate push update jobs may be enqueued for each of the 100 instances of the first application. Assuming no other push update jobs associated with another push update request are on the queue, the push update jobs may have a priority of 1, 2, 3 . . . 100.

Some time later, a second developer tenant requests a push update of 20 instances of a second application, each utilized by a respective subscriber tenant (e.g. assuming all subscriber tenants are associated with the same instance of the multi-tenant on-demand database service). Again separate push update jobs are enqueued for each of the 20 instances of the second application. If 50 of the 100 push update jobs requested by the first developer tenant have completed, the priority of the next push update job to be processed would be 51. Thus these new push update jobs requested by the second developer tenant may be given priorities interleaved with the remaining push update jobs requested by the first developer tenant. This may ensure a fairness policy across all push upgrade requests being processed. As another option, a push update requested for only a single subscriber tenant may be given highest priority automatically (since it may be assumed that the push update request is for testing purposes where quick feedback is desired).

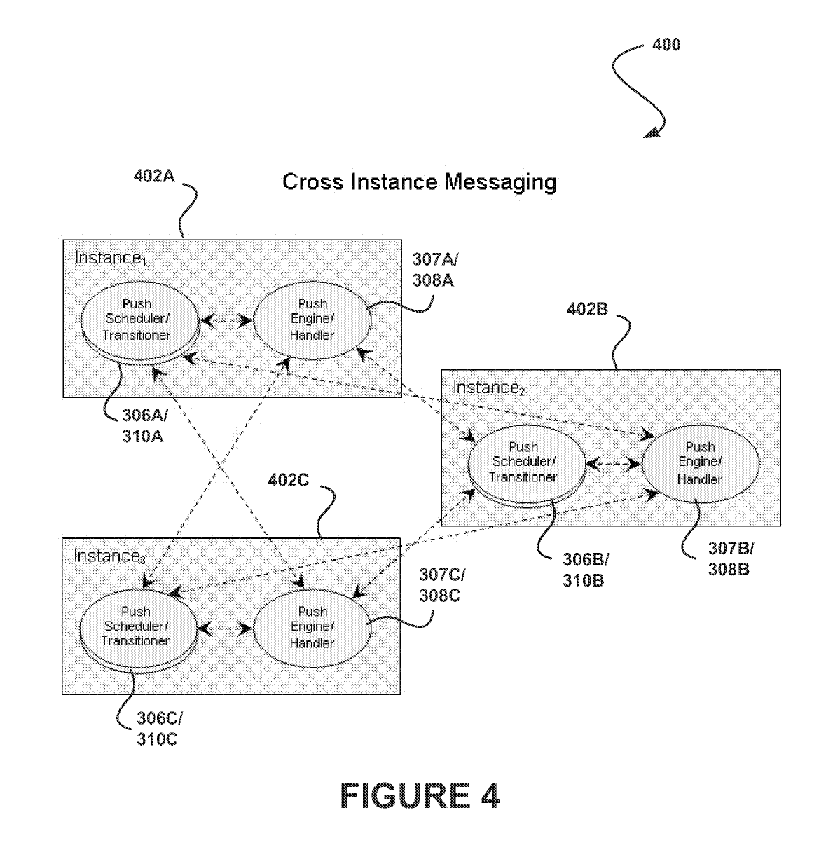

FIG. 4 shows a system 400 in which cross-instance messaging is provided for pushing an application update between tenants of a multi-tenant on-demand database service, in accordance with still yet another embodiment. As an option, the system 400 may be implemented in the context of the functionality of FIGS. 1-3. Of course, however, the system 400 may be implemented in any desired environment. Again, the aforementioned definitions may apply during the present description.

As shown, each instance 402A-C of a multi-tenant on-demand database service includes a push scheduler service 306A-C, a push transitioner service 310A-C, a push update engine 307A-C, and a push message handler 308A-C. The push scheduler service 306A-C and push transitioner service 310A-C are in communication with the push update engine 307A-C and push message handler 308A-C of each instance 402A-C. Thus, any instance 402A-C of the multi-tenant on-demand database service may receive an update to an application from a first tenant and replicate such update to the other instances 402A-C, such that the push scheduler service 306A-C and push transitioner service 310A-C of an instance 402A-C that received the update may ensure that the update is pushed to instances of the applications existing on each of the instances 402A-C utilizing the push update engine 307A-C and push message handler 308A-C all of such instances 402A-C.

For example, a first instance 402A may receive an update to an application. The push scheduler service 306A-C and push transitioner service 310A-C of that first instance 402A may communicate with (he push update engine 307A-C and push message handler 308A-C of all of the instances 402A-C. Such communication may instruct that the push update engine 307A-C and push message handler 308A-C of each instance 402A-C push the update to instances of the application existing thereon.

### System Overview

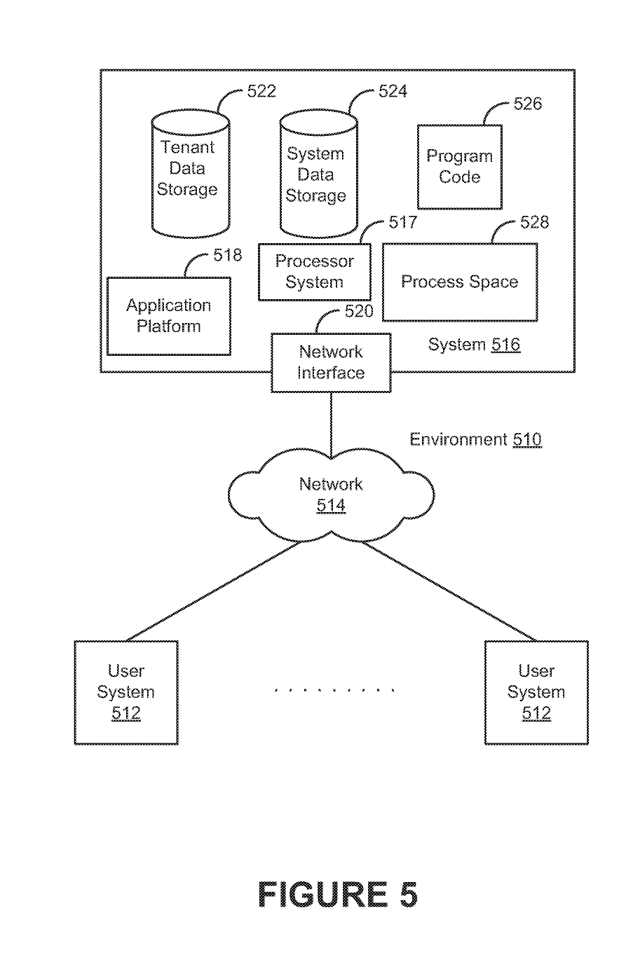

FIG. 5 illustrates a block diagram of an environment 510 wherein an on-demand database service might be used. As an option, any of the previously described embodiments of the foregoing figures may or may not be implemented in the context of the environment 510. Environment 510 may include user systems 512, network 514, system 516, processor system 517, application platform 518, network interface 520, tenant data storage 522, system data storage 524, program code 526, and process space 528. In other embodiments, environment 510 may not have all of the components listed and/or may have other elements instead of, or in addition to, those listed above.

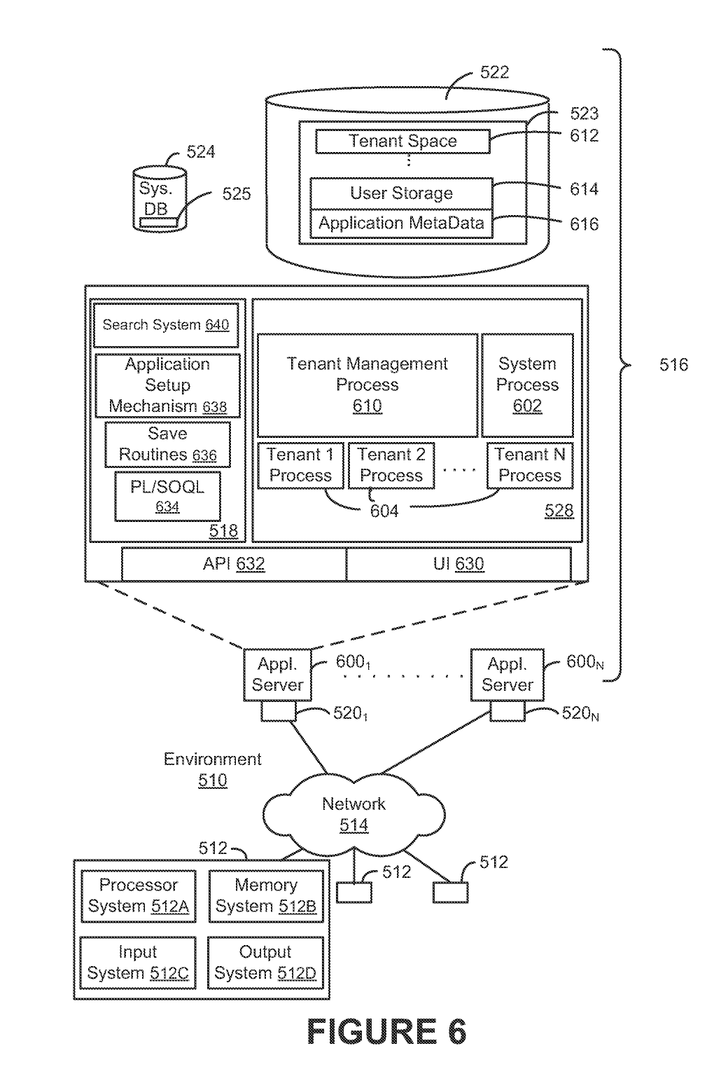

Environment 510 is an environment in which an on-demand database service exists. User system 512 may be any machine or system that is used by a user to access a database user system. For example, any of user systems 512 can be a handheld computing device, a mobile phone, a laptop computer, a work station, and/or a network of computing devices. As illustrated in FIG. 5 (and in more detail in FIG. 6) user systems 512 might interact via a network with an on-demand database service, which is system 516.

An on-demand database service, such as system 516, is a database system that is made available to outside users that do not need to necessarily be concerned with budding and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 516” and “system 516” will be used interchangeably herein. A database image may include one or more database objects. A relational database management system (RDMS) or the equivalent may execute storage and retrieval of information against the database object(s). Application platform 518 may be a framework that allows the applications of system 516 to run, such as the hardware and/or software, e.g., the operating system. In an embodiment, on-demand database service 516 may include an application platform 518 that enables creation, managing and executing one or more applications developed by the provider of the on-demand database service, users accessing the on-demand database service via user systems 512, or third party application developers accessing the on-demand database service via user systems 512.

The users of user systems 512 may differ in their respective capacities, and the capacity of a particular user system 512 might be entirely determined by permissions (permission levels) for the current user. For example, where a salesperson is using a particular user system 512 to interact with system 516, that user system has the capacities allotted to that salesperson. However, while an administrator is using that user system to interact with system 516, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 514 is any network or combination of networks of devices that communicate with one another. For example, network 514 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the present invention might use are not so limited, although TCP/IP is a frequently implemented protocol.

User systems 512 might communicate with system 516 using TCP/IP and, at a higher network level, use other common Internet protocols to communicate, such as HTTP, FTP, AFS, WAP, etc. In an example where HTTP is used, user system 512 might include an HTTP client commonly referred to as a “browser” for sending and receiving HTTP messages to and from an HTTP server at system 516. Such an HTTP server might be implemented as the sole network interface between system 516 and network 514, but other techniques might be used as well or instead. In some implementations, the interface between system 516 and network 514 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 516, shown in FIG. 5, implements a web-based customer relationship management (CRM) system. For example, in one embodiment, system 516 includes application servers configured to implement and execute CRM software applications as well as provide related data, code, forms, webpages and other information to and from user systems 512 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 516 implements applications other than, or in addition to, a CRM application. For example, system 516 may provide tenant access to multiple hosted (standard and custom) applications, including a CRM application. User (or third party developer) applications, which may or may not include CRM, may be supported by the application platform 518, which manages creation, storage of the applications into one or more database objects and executing of the applications in a virtual machine in the process space of the system 516.

One arrangement for elements of system 516 is shown in FIG. 6, including a network interface 520, application platform 518, tenant data storage 522 for tenant data 523, system data storage 524 for system data accessible to system 516 and possibly multiple tenants, program code 526 for implementing various functions of system 516, and a process space 528 for executing MTS system processes and tenant-specific processes, such as running applications as part of an application hosting service. Additional processes that may execute on system 516 include database indexing processes.

Several elements in the system shown in FIG. 5 include conventional, well-known elements that are explained only briefly here. For example, each user system 512 could include a desktop personal computer, workstation, laptop, PDA, cell phone, or any wireless access protocol (WAP) enabled device or any other computing device capable of interfacing directly or indirectly to the Internet or other network connection. User system 512 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g. subscriber of the multi-tenant database system) of user system 512 to access, process and view information, pages and applications available to it from system 516 over network 514. Each user system 512 also typically includes one or more user interface devices, such as a keyboard, a mouse, trackball, touch pad, touch screen, pen or the like, for interacting with a graphical user interface (GUI) provided by the browser on a display (e.g. a monitor screen, LCD display, etc.) in conjunction with pages, forms, applications and other information provided by system 516 or other systems or servers. For example, the user interface device can be used to access data and applications hosted by system 516, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 512 and all of its components are operator configurable using applications, such as a browser, including computer code run using a central processing unit such as an Intel Pentium® processor or the like. Similarly, system 516 (and additional instances of an MTS, where more than one is present) and all of their components might be operator configurable using application(s) including computer code to run using a central processing unit such as processor system 517 of FIG. 5, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 516 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g. extranet, VPN, LAN, etc.) using any communication medium and protocols (e.g. TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 516 is configured to provide webpages, forms, applications, data and media content to user (client) systems 512 to support the access by user systems 512 as tenants of system 516. As such, system 516 provides security mechanisms to keep each tenant's data separate unless the data is shared. If more than one MTS is used, they may be located in close proximity to one another (e.g. in a server farm located in a single building or campus), or they may be distributed at locations remote from one another (e.g. one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g. OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 6 also illustrates environment 510. However, in FIG. 6 elements of system 516 and various interconnections in an embodiment are further illustrated. FIG. 6 shows that user system 512 may include processor system 512A, memory system 512B, input system 512C, and output system 512D. FIG. 6 shows network 514 and system 516. FIG. 6 also shows that system 516 may include tenant data storage 522, tenant data 523, system data storage 524, system data 525, User Interface (UI) 630, Application Program Interface (API) 632, PL/SOQL 634, save routines 636, application setup mechanism 638, applications servers 600₁-600_{N}, system process space 602, tenant process spaces 604, tenant management process space 610, tenant storage area 612, user storage 614, and application metadata 616. In other embodiments, environment 510 may not have the same elements as those listed above and/or may have other elements instead of, or in addition to, those listed above.

User system 512, network 514, system 516, tenant data storage 522, and system data storage 524 were discussed above in FIG. 5. Regarding user system 512, processor system 512A may be any combination of one or more processors. Memory system 512B may be any combination of one or more memory devices, short term, and/or long term memory. Input system 512C may be any combination of input devices, such as one or more keyboards, mice, trackballs, scanners, cameras, and/or interfaces to networks. Output system 512D may be any combination of output devices, such as one or more monitors, printers, and/or interfaces to networks. As shown by FIG. 6, system 516 may include a network interface 520 (of FIG. 5) implemented as a set of HTTP application servers 600, an application platform 518, tenant data storage 522, and system data storage 524. Also shown is system process space 602, including individual tenant process spaces 604 and a tenant management process space 610. Each application server 600 may be configured to tenant data storage 522 and the tenant data 523 therein, and system data storage 524 and the system data 525 therein to serve requests of user systems 512. The tenant data 523 might be divided into individual tenant storage areas 612, which can be either a physical arrangement and/or a logical arrangement of data. Within each tenant storage area 612, user storage 614 and application metadata 616 might be similarly allocated for each user. For example, a copy of a user's most recently used (MRU) items might be stored to user storage 614. Similarly, a copy of MRU items for an entire organization that is a tenant might be stored to tenant storage area 612. A UI 630 provides a user interface and an API 632 provides an application programmer interface to system 516 resident processes to users and/or developers at user systems 512. The tenant data and the system data may be stored in various databases, such as one or more Oracle™ databases.

Application platform 518 includes an application setup mechanism 638 that supports application developers' creation and management of applications, which may be saved as metadata into tenant data storage 522 by save routines 636 for execution by subscribers as one or more tenant process spaces 604 managed by tenant management process 610 for example. Invocations to such applications may be coded using PL/SOQL 634 that provides a programming language style interface extension to API 632. A detailed description of some PL/SOQL language embodiments is discussed in commonly owned U.S. Provisional Patent Application 60/828,192 entitled, “PROGRAMMING LANGUAGE METHOD AND SYSTEM FOR EXTENDING APIS TO EXECUTE IN CONJUNCTION WITH DATABASE APIS,” by Craig Weissman, filed Oct. 4, 2006, which is incorporated in its entirety herein for all purposes. Invocations to applications may be detected by one or more system processes, which manage retrieving application metadata 616 for the subscriber making the invocation and executing the metadata as an application in a virtual machine.

Each application server 600 may be communicably coupled to database systems, e.g., having access to system data 525 and tenant data 523, via a different network connection. For example, one application server 600₁ might be coupled via the network 514 (e.g., the Internet), another application server 600_{N-1} might be coupled via a direct network link, and another application server 600_{N} might be coupled by yet a different network connection. Transfer Control Protocol and Internet Protocol (TCP/IP) are typical protocols for communicating between application servers 600 and the database system. However, it will be apparent to one skilled in the art that other transport protocols may be used to optimize the system depending on the network interconnect used.

In certain embodiments, each application server 600 is configured to handle requests for any user associated with any organization that is a tenant. Because it is desirable to be able to add and remove application servers from the server pool at any time for any reason, there is preferably no server affinity for a user and/or organization to a specific application server 600. In one embodiment, therefore, an interface system implementing aloud balancing function (e.g., an F5 Big-IP load balancer) is communicably coupled between the application servers 600 and the user systems 512 to distribute requests to the application servers 600. In one embodiment, the load balancer uses a least connections algorithm to route user requests to the application servers 600. Other examples of load balancing algorithms, such as round robin and observed response time, also can be used. For example, in certain embodiments, three consecutive requests from the same user could hit three different application servers 600, and three requests from different users could hit the same application server 600. In this manner, system 516 is multi-tenant, wherein system 516 handles storage of, and access to, different objects, data and applications across disparate users and organizations.

As an example of storage, one tenant might be a company that employs a sales force where each salesperson uses system 516 to manage their sales process. Thus, a user might maintain contact data, leads data, customer follow-up data, performance data, goals and progress data, etc., all applicable to that user's personal sales process (e.g., in tenant data storage 522). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 516 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 516 might also maintain system level data usable by multiple tenants or other data. Such system level data might include industry reports, news, postings, and the like that are sharable among tenants.

In certain embodiments, user systems 512 (which may be client systems) communicate with application servers 600 to request and update system-level and tenant-level data from system 516 that may require sending one or more queries to tenant data storage 522 and/or system data storage 524. System 516 (e.g., an application server 600 in system 516) automatically generates one or more SQL statements (e.g., one or more SQL queries) that are designed to access the desired information. System data storage 524 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to the present invention. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “CUSTOM ENTITIES AND FIELDS IN A MULTI-TENANT DATABASE SYSTEM,” which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

It should be noted that any of (he different embodiments described herein may or may not be equipped with any one or more of the features set forth in one or more of the following published applications: US2003/0233404, titled “OFFLINE SIMULATION OF ONLINE SESSION BETWEEN CLIENT AND SERVER,” filed Nov. 4, 2002; US2004/0210909, titled “JAVA OBJECT CACHE SERVER FOR DATABASES,” filed Apr. 17, 2003, now issued U.S. Pat. No. 7,209,929; US2005/0065925, titled “QUERY OPTIMIZATION IN A MULTI-TENANT DATABASE SYSTEM,” filed Sep. 23, 2003; US2005/0223022, titled “CUSTOM ENTITIES AND FIELDS IN A MULTI-TENANT DATABASE SYSTEM,” filed Apr. 2, 2004; US2005/0283478, titled “SOAP-BASED WEB SERVICES IN A MULTI-TENANT DATABASE SYSTEM,” filed Jun. 16, 2004; US2006/0206834, titled “SYSTEMS AND METHODS FOR IMPLEMENTING MULTI-APPLICATION TABS AND TAB SETS,” filed Mar. 8, 2005; and/or US2008/0010243, titled “METHOD AND SYSTEM FOR PUSHING DATA TO A PLURALITY OF DEVICES IN AN ON-DEMAND SERVICE ENVIRONMENT,” filed Jun. 1, 2007; which are each incorporated herein by reference in their entirety for all purposes.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product embodied on a tangible computer readable medium, comprising:
computer code for receiving an update to an application from a first tenant of a multi-tenant on-demand database service; and
computer code for pushing the update to at least one instance of the application utilized by a respective second tenant of the multi-tenant on-demand database service.

2. The computer program product of claim 1, wherein the update includes a patch to the application.

3. The computer program product of claim 1, wherein the first tenant includes a developer of the application that utilized the multi-tenant on-demand database service to generate the update to the application.

4. The computer program product of claim 1, wherein the computer program product is operable such that each instance of the application is utilized by one of a plurality of different second tenants of the multi-tenant on-demand database service.

5. The computer program product of claim 1, further comprising computer code for confirming the update to the at least one instance of the application prior to automatically pushing the update to the at least one instance of the application.

6. The computer program product of claim 5, wherein the computer program product is operable such that the update is automatically pushed to the at least one instance of the application based on the confirmation.

7. The computer program product of claim 1, wherein the at least one instance of the application utilized by the respective second tenant is installed on a first instance of the multi-tenant on-demand database service separate from a second instance of the multi-tenant on-demand database service by which the update is received, such that the update is replicated from the second instance to the first instance for automatically pushing the update to the at least one instance of the application utilizing the first instance.

8. A method, comprising;
receiving an update to an application from a first tenant of a multi-tenant on-demand database service; and
pushing the update to at least one instance of the application utilized by a respective second tenant of the multi-tenant on-demand database service.

9. An apparatus, comprising:
a processor for:
receiving an update to an application from a first tenant of a multi-tenant on-demand database service, and
pushing the update to at least one instance of the application utilized by a respective second tenant of the multi-tenant on-demand database service.

10. A method for transmitting code for use in a multi-tenant database system on a transmission medium, the method comprising;
transmitting code for receiving an update to an application from a first tenant of a multi-tenant on-demand database service; and
transmitting code for pushing the update to at least one instance of the application utilized by a respective second tenant of the multi-tenant on-demand database service.
